(19) United States
(12) Patent Application Publication
(10) Pub. No.: US 2015/0159808 A1
(43) Pub. Date: Jun. 11, 2015

(54) High Pressure Packaging For A NO/Nitrogen Gaseous Mixture

(71) Applicant: AIR LIQUIDE SANTE (INTERNATIONAL), Paris (FR)

(72) Inventors: Pierre De Villemeur, Louveciennes (FR); Laurent Lecourt, Cachan (FR)

(73) Assignee: AIR LIQUIDE SANTE (INTERNATIONAL), Paris (FR)

(21) Appl. No.: 14/400,576

(22) PCT Filed: Apr. 15, 2013
(86) PCT No.: PCT/FR2013/050818

§ 371 Date: Nov. 12, 2014

(30) Foreign Application Priority Data
May 24, 2012 (FR) 1254766

(51) Int. Cl. F17C 1/14

(52) U.S. Cl. CPC F17C 1/14; F17C 2201/0104; F17C 2221/03; F17C 2270/025

(57) ABSTRACT

The invention concerns a method of storing a NO/N2 mixture in a packaging container, in particular a gas bottle, having an internal volume less than or equal to 12 liters, characterized in that a NO/N2 gaseous mixture containing between 400 ppm and 1000 ppm by volume of NO and nitrogen for the remainder is held at a pressure of at least 250 bar in the internal volume of said container. Preferably, the NO/N2 gaseous mixture is held at a pressure of 280 to 450 bar, and preferably between 300 and 420 bar.

### CROSS REFERENCE TO RELATED APPLICATIONS

This application is a 371 of International Application PCT/FR2013/050818 filed Apr. 15, 2013, which claims priority to French Application No. 1254766 filed May 24, 2012, the entire contents of which are incorporated herein by reference.

### BACKGROUND

The invention relates to the use of an NO cylinder having an internal volume of 12 liters or less, which is suitable for and designed for containing a mixture of NO and nitrogen (NO content>400 ppmv) packaged at a pressure of at least 250 bar, preferably between 300 and 500 bar.

Gaseous NO is conventionally used at various concentrations ranging from 100 to 800 ppm by volume (hereinafter “ppmv”), the remainder of the gas mixture being nitrogen, for treating pulmonary vasoconstrictions, especially pulmonary hypertension in patients undergoing a cardiac surgery operation or in hypoxic newborns. In this regard, mention may be made of documents EP-A-786264 and EP-1516639.

Cylinders of NO/N₂ that contain NO at the initial concentration typically between 100 and 800 ppmv may adopt various sizes ranging from 2 to 40 liters (equivalent water capacity).

However, the doses of NO administered to patients range from 1 to 40 ppmv and the administration times vary from a few hours to a few days, for example up to 4 days on average, depending on the patient in question and his clinical condition.

The NO must therefore be diluted, typically with air, O₂-enriched air or N₂/O₂ mixtures, prior to being administered to patients in order to decrease the concentration thereof to less than 40 ppmv, that is to say to the desired dosage for the patient in question. This dilution is generally carried out in the patient circuit of a ventilator.

Yet the crowded state of resuscitation rooms and operating blocks, and the use of compact NO administration and monitoring systems intended to enable easier transport of patients, make it difficult to use NO/N₂ cylinders of large size, that is to say of more than 12 liters (water capacity), typically those of 20 liters.

Specifically, such cylinders lead to significant overcrowding in hospital treatment rooms, are difficult to handle for the care staff, pose problems of storage and transport in buildings, etc.

However, reducing the size of the gas cylinders is not sufficient as this leads to a significant loss of autonomy, that is to say that they do not contain a sufficient amount of gas in order to be able to ensure that NO is dispensed for the required treatment time that may extend over several hours, or even several days.

The problem is consequently to be able to provide NO/N₂ mixtures in a small-sized storage container, that is to say having a capacity (water equivalent) of less than 12 liters, without encountering or while minimizing the aforementioned autonomy problems, that is to say small cylinders containing a sufficient amount of gas to enable the treatment of a patient over a treatment time of at least 12 to 24 hours without requiring the cylinder to be changed, preferably at least 1 to 4 days, or even longer.

### SUMMARY

The solution is a process for storing an NO/N₂ mixture in a packaging container having an internal volume of less than or equal to 12 liters, characterized in that an NO/N₂ gas mixture containing from 400 ppm to 1000 ppm by volume of NO and nitrogen for the remainder is kept, i.e stored, at a pressure of at least 250 bar, in the internal volume of said container.

In other words, according to the present invention, in order to compensate for the reduction in the size of the packaging container, typically a gas cylinder, while retaining a sufficient autonomy of the container that makes it suitable for being used to treat patients suffering from pulmonary vasoconstrictions, the pressure of the NO/nitrogen mixture packaged in the container is increased.

Indeed, an increase in the pressure of the gas packaged in the cylinder (at constant volume) increases the amount of NO available but without necessarily increasing its concentration, which avoids the aforementioned problems.

Furthermore, this also makes it possible to avoid any excessive dose or any excessively large administration of NO due to a poor dilution or to an uncontrolled administration.

Moreover, this also makes it possible to reduce the size and space requirement of the cylinders by making them easier to transport and handle in an intrahospital and extrahospital environment.

However, the increase in pressure necessitates being able to provide cylinders capable of withstanding such pressures, or even significantly higher pressures. Indeed, for obvious safety reasons, the cylinders must be capable of withstanding pressures much higher than their normal operating pressure, typically a pressure 1.5 times higher than its normal operating pressure. Thus, a cylinder intended to contain an NO/nitrogen mixture at 300 bar must be able to withstand a maximum pressure of 450 bar, also referred to as test pressure.

Depending on the case, the process of the invention may comprise one or more of the following technical features:

the container is formed from a composite, such as fiberglass or carbon fibers, or the like, or from an aluminum alloy comprising aluminum (Al), from 1.8% to 2.6% of copper (Cu), from 1.3% to 2.1% of magnesium (Mg) and from 6.1% to 7.5% of zinc (Zn), preferably an aluminum alloy is used that additionally comprises (% by weight) from 0 to 0.15% of silicon (Si).

an aluminum alloy is used that comprises (% by weight) from 86.7% to 90.7% of aluminum.

a container formed from an aluminum alloy having a density of between 2 and 3.5 g/cm³, preferably between 2.5 and 3 g/cm³, typically of the order of 2.85 g/cm³ is used. p a container of cylindrical shape having a diameter between 5 and 40 cm and a height between 10 and 80 cm is used.

a container is used that has a peripheral wall having a thickness E of less than 30 mm.

the container is a gas cylinder.

the container of cylindrical shape comprises, at one end, a base and, at the other end, a neck with an outlet orifice, attached to which is a device for controlling the gas flow and/or for reducing the pressure.

the NO/N₂ gas mixture at least 450 ppm by volume of NO, preferably up to 900 ppmv of NO, and nitrogen for the remainder.

the NO/N₂ gas mixture is stored at a pressure of from 280 to 450 bar, preferably between 300 and 420 bar.

the packaging container has an internal volume of less than or equal to 11 liters.

the container (6) contains the NO/N₂ gas mixture at a pressure between 300 and 500 bar.

### BRIEF DESCRIPTION OF THE DRAWING

The present invention will now be better understood owing to the description given below with reference to the appended figure.

FIG. 1 represents one embodiment of an installation for dispensing NO supplied by a gas packaging system according to the present invention.

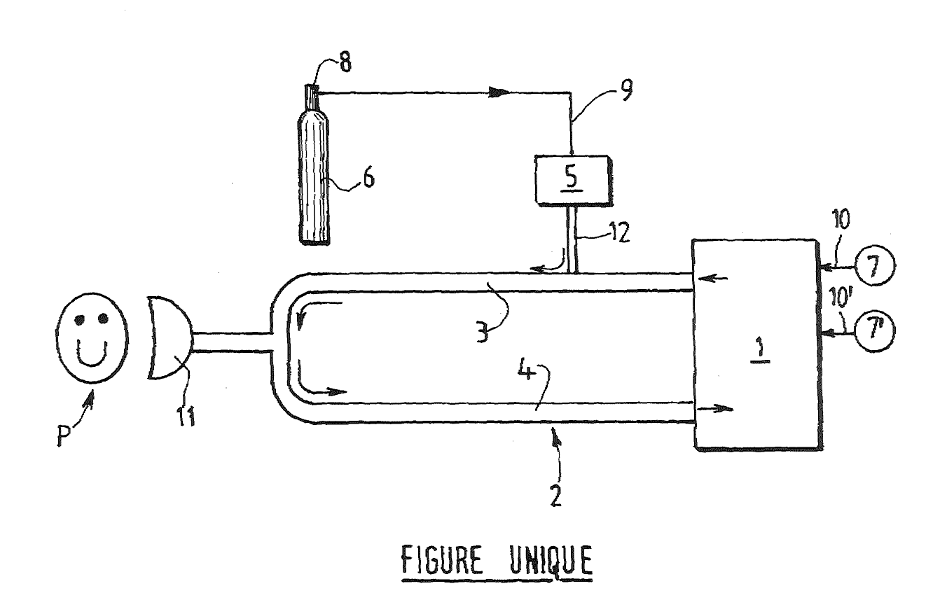

### DESCRIPTION OF PREFERRED EMBODIMENTS

Several cylinders 6 of different sizes, made of an aluminum alloy of metallurgical composition given in the table below are used for storing, at high pressure, a gas mixture formed of nitrogen monoxide (NO) and nitrogen (N₂).

TABLE 1

| | Proportion (%) by weight |
|---|---|
| Elements | of the alloy |
| Pb | 0 to 0.003 |
| Fe | 0 to 0.2 |
| Si | 0 to 0.15 |
| Cu | 1.8 to 2.6 |
| Mn | 0 to 0.2 |
| Mg | 1.3 to 2.1 |
| Cr | 0.15 to 0.25 |
| Zn | 6.1 to 7.5 |
| Ti | 0 to 0.05 |
| Zr | 0 to 0.05 |
| Impurities | 0 to 0.15 |
| Al | remainder |
| Density of the alloy | 2.85 g/cm³ approximately |

The cylinders are equipped with an integrated valve regulator 8, also referred to as IVR, that makes it possible to control the output of gas from the container 6. More specifically, the NO/N₂ gas mixture that is packaged therein comprises an NO content of between 400 and 1000 ppm, for example of the order of 800 ppmv, and was introduced under a high pressure into cylinders of B1, B2, B5 and B11 type, the equivalent water capacity of which is, respectively, 1, 2, 5 and 11 liters.

According to the invention, the gas pressure in the cylinders 6 is at least 250 bar in the internal volume of each cylinder, preferably between 300 and 500 bar. The cylinders thus obtained contain in the end the NO/N₂ mixture at a pressure of the order of 300 bar and at a content of 800 ppmv.

These cylinders were used for supplying an installation for dispensing NO to patients suffering from pulmonary vasoconstrictions, for example an installation for dispensing NO, one embodiment of which is shown schematically in the sole appended figure.

This installation comprises a ventilator 1 comprising a respiratory circuit or patient circuit 2 with two branches, that is to say with an inhalation branch 3 and an exhalation branch 4. The inhalation branch 3 is designed to convey respiratory gas from the ventilator 1 to the patient P, whereas the exhalation branch 4 is designed to convey the gas exhaled by the patient P to the ventilator 1. At the patient P, the gas is administered by means of a patient interface 11, for example a respiratory mask or a tracheal cannula or catheter.

The ventilator 1 is supplied, via several delivery lines 10, 10′, with air (O₂ content of 21% by volume) originating from an air source 7 and with oxygen resulting from an oxygen source 7′, such as gas cylinders or lines transporting, respectively, medical air and oxygen originating from an oxygen production unit, such as a pressure swing (PSA) unit, or from an oxygen storage unit, such as a buffer or storage tank. The air is enriched in oxygen in the ventilator 1 and the oxygen-rich gas thus obtained is delivered by the ventilator 1 into the inhalation branch 3 of the patient circuit 2.

Furthermore, a device 5 for dispensing NO is fluidically connected to said inhalation branch 3 of the patient circuit 2 in order to deliver thereto, via a feed line 12, an NO/N₂ mixture having a concentration of at least 400 ppm by volume. The device 5 for dispensing NO is itself supplied with an NO/N₂ mixture, via a gas feed line 9, by an NO container 6 according to the invention, such as an aluminum gas cylinder (cf. Table 1) equipped with a valve or integrated valve regulator 8, preferably protected by a cap for protection against impacts.

The device 5 for dispensing NO makes it possible to control the amount of NO/N₂ released into the inhalation branch 3, and also the method of releasing this mixture, that is to say continuously or in a pulsed manner, for example only during the inhalation phases of the patient P. Therefore, in the inhalation branch 3, a dilution of the NO/N₂ mixture with the oxygen-rich gas distributed by the ventilator 1 takes place. The dilution depends on the content of the initial NO/N₂ mixture and also on the concentration of gas to be administered to the patient.

Table 2 below gives the capacity (in liters of gas) of various packagings having capacities of 0.5 to 20 liters (i.e. B0.5 to B20) at various pressures (in bar).

TABLE 2

| | Filling pressure (bar) | | | | | |
|---|---|---|---|---|---|---|
| | 150 bar | 200 | 250 | 300 | 350 | 400 |
| Type of cylinder | vol L | | | | | |
| B0.5 | 75 | 100 | 125 | 150 | 175 | 200 |
| B1 | 150 | 200 | 250 | 300 | 350 | 400 |
| B2 | 300 | 400 | 500 | 600 | 700 | 800 |
| B5 | 750 | 1000 | 1250 | 1500 | 1750 | 2000 |
| B10 | 1500 | 2000 | 2500 | 3000 | 3500 | 4000 |
| B20 | 3000 | 4000 | 5000 | 6000 | 7000 | 8000 |

In fact, the NO consumption will depend on the type of patient, that is to say adult, child or newborn, and also on the ventilation method and on the desired NO dosage.

Table 3 below gives the volumes of NO necessary for the treatment of an adult patient ventilated with a minute volume of 10 l/min.

TABLE 3

| | | Concentration in | | | | |
|---|---|---|---|---|---|---|
| | | the cylinder (ppm) | | | | |
| | | 225 | 450 | 900 | 1500 | 2250 |
| | NO dose (ppm) | vol ml/min | | | | |
| Daily | 5 | 327 | 160 | 80 | 48 | 48 |
| volume | 10 | 655 | 320 | 160 | 96 | 96 |
| (liters) | 20 | 1309 | 640 | 320 | 193 | 193 |
| Volume for | 5 | 1309 | 640 | 320 | 193 | 193 |
| 4 days | 10 | 2618 | 1280 | 640 | 385 | 385 |
| (liters) | 20 | 5236 | 2560 | 1280 | 771 | 771 |

As can be seen in the above table, for a concentration of 450 ppm, a cylinder of B5 type (5 liter equivalent water capacity) containing NO/N₂ packaged at a pressure of 400 bar, therefore providing 2000 liters of gas, makes it possible to treat an adult patient at a dosage of 20 ppmv over a duration of around 3 days.

Under these same concentration and filling pressure conditions, a daily treatment of this patient is possible with a cylinder of B2 type (25 liter equivalent water capacity).

In all cases, the weight and space requirement of these cylinders at such a pressure are substantially reduced compared to those of the cylinders of the prior art. It follows therefrom that the combination of a high concentration of NO (i.e. more than 400 ppmv) and a high filling pressure (i.e. more than 250 bar) makes it possible to considerably reduce the size of the packagings and to facilitate the use thereof in a hospital environment.

This characteristic is even more pronounced in newborns. Thus, table 4 below thus shows the volumes of NO necessary for the treatment of newborns ventilated with a minute volume of 2 l/min.

TABLE 4

| | | Concentration in | | | | | |
|---|---|---|---|---|---|---|---|
| | | the cylinder (in ppmv) | | | | | |
| | | 225 | 450 | 800 | 900 | 1500 | 2250 |
| Daily | 5 | 65 | 32 | 18 | 16 | 10 | 6 |
| volume | 10 | 131 | 65 | 36 | 32 | 19 | 13 |
| (liters) | 20 | 262 | 129 | 72 | 64 | 39 | 26 |
| Volume for | 5 | 262 | 129 | 72 | 64 | 39 | 26 |
| 4 days | 10 | 524 | 259 | 145 | 129 | 77 | 51 |
| (liters) | 20 | 1047 | 518 | 290 | 257 | 154 | 103 |

It is seen that for a concentration of 450 ppm, a cylinder of B1 type (1 liter equivalent water capacity) at 400 bar providing 400 liters of gas makes it possible to treat a newborn at a dosage of 20 ppmv over a duration of 4 days.

Under these same concentration and filling pressure conditions, a daily treatment of this patient is possible with a cylinder of barely around 250 cm³.

In view of these tables, the advantage of using a cylinder having an internal volume of less than or equal to 12 liters for packaging a mixture of NO and nitrogen at a pressure of at least 250 bar, preferably between 300 and 500 bar, when the NO/N₂ gas mixture contains from 400 ppm to 1000 ppm by volume of NO, and nitrogen for the remainder, is immediately understood.

Packaging the NO at high pressure, i.e. at least 450 bar, makes it possible to reduce the size of the packaging cylinders used (<12 liters), and therefore to solve the aforementioned overcrowding problems and to make it possible furthermore to adapt the packaging to a daily treatment or treatment per patient in a manner similar to conventional treatments, therefore to enable better monitoring of the treatment received by the patient.

1-15. (canceled)

16. A process for storing an NO/N₂ mixture in a packaging container (6) having an internal volume of less than or equal to 12 liters, comprising a step of storing an NO/N₂ gas mixture containing from 400 ppm to 1000 ppm by volume of NO and nitrogen for the remainder, at a pressure of at least 250 bar, in the internal volume of said container.

17. The process of claim 1, wherein the container (6) is formed from a composite or from an aluminum alloy comprising aluminum (Al), from 1.8% to 2.6% of copper (Cu), from 1.3% to 2.1% of magnesium (Mg) and from 6.1% to 7.5% of zinc (Zn).

18. The process of claim 2 wherein the aluminum alloy is used that comprises (% by weight) from 86.7% to 90.7% of aluminum.

19. The process of claim 2 wherein the container (6) is formed from an aluminum alloy having a density of between 2 and 3.5 g/cm³ is used.

20. The process of claim 1 wherein the container (6) has a cylindrical shape having a diameter between 5 and 40 cm and a height between 10 and 80 cm is used.

21. The process of claim 5 wherein the container (6) is a gas cylinder.

22. The process of claim 1 wherein the container (6) of cylindrical shape comprises, at one end, a base and, at the other end, a neck with an outlet orifice, attached to which is a device for controlling the gas flow and/or for reducing the pressure (8).

23. The process of claim 1 wherein the NO/N₂ gas mixture contains from 450 ppm to 1000 ppm by volume of NO by volume of NO, and nitrogen (N₂) for the remainder.

24. The process of claim 1 wherein the NO/N₂ gas mixture is packaged at a pressure of 280 to 500 bar.

25. The process of claim 1 wherein the container (6) has an internal volume of less than or equal to 11 liters.

26. The process of claim 1 wherein the container (6) contains the NO/N₂ mixture at a pressure between 300 and 500 bar.

27. The process of claim 1 wherein the NO/N₂ gas mixture contains 400 ppmv to 900 ppmv of NO.

28. The process of claim 1 wherein the NO/N₂ gas mixture is packaged at a pressure of 280 to 450 bar.

29. The process of claim 1 wherein the NO/N₂ gas mixture is stored at a pressure between 300 and 420 bar.

30. The process of claim 1 wherein the container is a gas cylinder, the equivalent water capacity of which is 0.5, 1, 2, 5 or 11 liters.
